(19) United States
(12) Patent Application Publication
(10) Pub. No.: US 2004/0258217 A1
(43) Pub. Date: Dec. 23, 2004

(54) Voice notice relay service method and apparatus

(76) Inventor: Ki Chul Kim, Sungnam City (KR)

Correspondence Address: BIRCH STEWART KOLASCH & BIRCH, PO BOX 747, FALLS CHURCH, VA, 22040-0747, US

(21) Appl. No.: 10/851,149

(22) Filed: May 24, 2004

(30) Foreign Application Priority Data
May 30, 2003 (KR) 10-2003-34840

(51) Int. Cl. H04M 1/64; H04J 3/06

(52) U.S. Cl. 379/88.17; 715/513

(57) ABSTRACT

Disclosed herein is a relay service method for voice notice and a computer system for executing the same. In the present invention, a relay service company receives basic data for ARS voice notice from a user company, converts the basic data into a standardized markup language format, and transmits the markup language data to a communication network company, and the communication network company interprets the transmitted markup language data using a markup language interpreter, calls a customer, and executes a scenario. Accordingly, the various functions of a markup language can be utilized, high costs required for user companies to construct ARS voice notice systems, respectively, can be reduced, and a constructed ARS voice notice system can be utilized effectively.

### BACKGROUND OF THE INVENTION

1. Field of the Invention

The present invention relates generally to a relay service method for voice notice and a computer system for executing the same.

2. Description of the Related Art

In a current Automatic Response System (ARS) for voice notice system using a telephone, a specific phone number is dialed, the contents of the notice are transmitted in voice to a person, a response of the person, such as “yes” or “no,” is received using the buttons of a telephone, and the person can be directly connected to the call center of a company and makes a call with the call center in case of need (these operations are also referred to as “voice notice”). Therefore, in order for a company to perform ARS voice notice, ARS should be constructed in the company.

In the meantime, to construct the ARS voice notice system in a company, not only hardware, including an ARS server, a voice synthesis board and telephone equipment, but also software, including an Operating System (OS), a Text-To-Speech (TTS) engine and an automatic speech recognition (ASR) engine, must be possessed, and high costs and man power are required to maintain the hardware and the software and to construct and modify scenarios for ARS. ARS voice notice systems constructed by respective companies as described above are connected to the telephone lines of communication network companies, such as “Korea Telecommunication Co.,” and perform ARS voice notice.

When the ARS voice notice systems are respectively constructed by the companies, high costs are required to purchase the hardware and the software and to use manpower for the maintenance thereof, so that there has been difficulty in respective companies constructing the ARS voice notice systems.

Furthermore, to perform ARS voice notice, a user company should ensure a telephone line based on a contract for the use of the telephone line with a communication network company (for example, “Korea Telecommunication Co.”). In the period for which ARS voice notice is not continuously performed, for example, the period other than the period of demanding payment in an ARS voice notice system that is used to notify credit card users of an outstanding balance with a credit card company, ARS voice notice is not frequently performed, so that the ARS voice notice system and the telephone line are insufficiently used.

Meanwhile, voice notice messages used to generate voice in the ARS voice notice system are composed of scenarios. Each of the scenarios can be classified into constant parts and changeable parts.

When the case where a credit card company performs voice notice based on the scenario “Hello! Mr. Jack. Your outstanding balance is 10 US dollars” to notify the user of an outstanding balance is taken as an example, the parts “Mr. Jack” and “10 US dollars” changes with a voice notice (that is, changeable parts), and the parts “Hello!” and “Your outstanding balance is” are constant (that is, constant parts).

In a conventional technology, when a voice message is constant (for example, “Your account is not balanced. Please, balance your account”), the constant voice message is previously recorded and delivered to customers. For a scenario having both constant and changeable parts, the constant part is recorded and the changeable part is input in letter and reproduced through the conversion of the changeable part using a TTS engine, or both constant and changeable parts are reproduced through synthesis using a TTS engine.

In the meantime, when the recorded voice or voice synthesized by the TTS engine is utilized, related software written in the C or C⁺⁺ language must be changed to change scenarios and, thus, it is difficult for the persons other than experts to perform such a change.

### SUMMARY OF THE INVENTION

Accordingly, the present invention has been made keeping in mind the above problems occurring in the prior art, and an object of the present invention is to provide a relay service method for voice notice and a computer system for executing the same, in which a relay service company receives basic data for ARS voice notice from a user company, converts the basic data into a standardized markup language format, and transmits the markup language data to a communication network company, and the communication network company interprets the transmitted markup language data using a markup language interpreter, calls a customer, and executes a scenario, so that the various functions of a markup language can be utilized, high costs required for user companies to construct ARS voice notice systems, respectively, can be reduced, and a constructed ARS voice notice system can be utilized effectively.

In order to accomplish the above object, the present invention provides a processing method in a computer for relay service, including the steps of receiving information about constant parts of a scenario for a voice notice message, information about changeable parts thereof related to respective customers, and information about phone numbers of the customers; creating markup language code based on the received information; and transmitting the created markup language code to a communication network so that the communication network communicates with customers and performs Automatic Response Service (ARS) voice notice.

In addition, the present invention provides a computer apparatus for relay service, including mean for receiving information about constant parts of a scenario for a voice notice message, information about changeable parts thereof related to respective customers, and information about phone numbers of the customers; mean for creating markup language code based on the received information; and means for transmitting the created markup language code to a communication network so that the communication network communicates with customers and performs ARS voice notice.

In addition, the present invention provides a processing method in a computer apparatus for ARS voice notice, including the steps of receiving makeup language code from a computer apparatus for relay service of ARS voice notice that receives information about constant parts of a scenario for a voice notice message, information about changeable parts thereof related to respective customers and information about phone numbers of the customers, and creates markup language code based on the received information; and interpreting the received markup language code, and performing ARS voice notice to the customers via a communication network.

In addition, the present invention provides a computer apparatus for ARS voice notice, including means for receiving makeup language code from a computer apparatus for relay service of ARS voice notice that receives information about constant parts of a scenario for a voice notice message, information about changeable parts thereof related to respective customers and information about phone numbers of the customers, and creates markup language code based on the received information; and means for interpreting the received markup language code, and performing ARS voice notice to the customers via a communication network.

### BRIEF DESCRIPTION OF THE DRAWINGS

The above and other objects, features and advantages of the present invention will be more clearly understood from the following detailed description taken in conjunction with the accompanying drawing, in which:

FIG. 1 is a configuration diagram of the present system.

### DESCRIPTION OF THE PREFERRED EMBODIMENTS

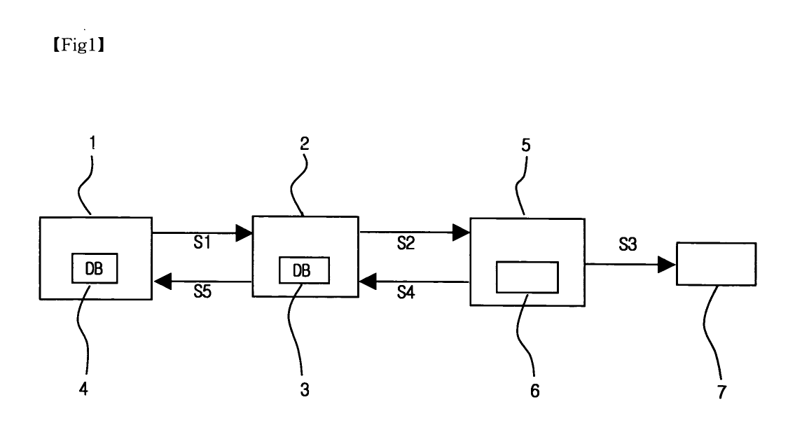

The construction and operation of the present are described with reference to FIG. 1 below.

First, a markup language is described.

A created scenario should be coded in a computer-understandable language. For makeup languages for writing voice notice scenarios, there are a variety of markup languages, including Voice extensible Markup Language (VoiceXML), Speech Application Language Tag (SALT), Call Control extensible Markup Language (CCXML), Speech Synthesis Markup Language (SSML) and Speech Recognition Grammar Specification (SRGS).

Each of the markup languages has unique features. For example, VoiceXML is most widely used. SSML is capable of assigning a gender and an age for voice when a scenario is reproduced in TTS, so that scenarios can be reproduced in various voices suitable for genders and ages through the use of SSML. CCXML has a function of calling a plurality of persons and delaying a conference between the plurality of persons. SRGS has a semantic interpretation function that, for example, can know “the place” to be “Seoul” in the case where a customer says “Seoul” previously and says “the place” later during the conversation between an ARS server and the customer.

Hereinafter, the present invention is described based on the case where VoiceXML is employed as a representative markup language.

A relay service company 2 groups user companies 1, creates lists of basic notice messages suitable for respective groups, and stores each list of basic notice messages in the DataBase (DB) 3 of the website thereof with respect to each of the groups. Additionally, scenarios corresponding to respective notice messages are stored in the DB 3.

Each of the user companies 1 accesses the website of the relay service company 2, contracts for ARS voice notice, selects an appropriate group, reviews a list of basic notice messages prepared for the group, and select one (for example, a notice message for a demand for payment) from the list of basic notice messages. Thereafter, a scenario (for example, “Hi! Mr. A. Your current balance is B US dollars”) corresponding to the selected notice message is retrieved from the DB 3 and, then, transmitted to the user company 1, and the scenario is settled if the user company accepts the scenario. If the appropriate notice message does not exist in the list of basic notice messages, or a corresponding scenario needs to be modified, the user company 2 creates basic data for a desired notice message and provides the basic data to the relay service company 2. The relay service company 2 having received the basic data prepares a scenario based on the basic data, and obtains the user company's consent to the scenario.

If the scenario, for which consent is obtained from the user company, is achieved and the scenario has the content “Hi! Mr. A. Your current balance is B US dollars,” the user company 1 transmits data (A: name, and B: balance) corresponding to changeable parts and phone number data (C: phone number), which are previously created and stored in the DB 4 of the user company 1, to the relay service company 2 at step S1.

The relay service company 2 having received the constant parts of the scenario, a list of data A and B for the changeable parts of the scenario and a list of phone number data C creates VoiceXML code based on the list of data A and B, the list of phone number data C, and the settled scenario. The VoiceXML code created as described above is transmitted to the communication network company 5 via the Internet or a dedicated line at step S2.

The communication network company 5 interprets the VoiceXML code transmitted from the relay service company 2 because it is provided with a VoiceXML interpretation server 6, dials the phone number C of a customer using the transmitted data A, B and C, and performs ARS voice notice using TTS, ASR and Dual Tone Multi-Frequency (DTMF; which allows the customer 7 to make inputs to the ARS voice notice system) at step S3.

The communication network company 5 having performed the ARS voice notice hands over the results of the ARS voice notice (for example, the numbers of successful calls and unsuccessful calls, or the results of a questionnaire) to the relay service company 2 at step S4. The relay service company 2 transmits the results of the ARS voice notice to the user company 1, bills the user company 1 for the results at step 5, or uses the results of the ARS voice notice as information for improvement in work.

In particular, when the customer 7 wants to call the call center of the user company 1 while the server of the communication network company 5 is performing ARS voice notice or finishes ARS voice notice, the communication network company 5 may call the call center of the user company 1 via another line and make the customer be connected to the call center.

With the above-described scheme, the user company 1 can perform ARS voice notice at low costs based on a contract with the relay service company 2, so that high costs required for each user company to construct and maintain an ARS voice notice system can be reduced.

Furthermore, since VoiceXML is used, the relay service company 2 can easily modify VoiceXML code according to the change of a scenario and a variety of services can be provided through the above-described various functions of VoiceXML.

Meanwhile, although the user company 1 has been described as contracting for relay service and performing the selection of a scenario and the provision of related information while accessing the website of the relay service company 2 on-line via the Internet, some or all of the service contact, the selection of the scenario and the provision of related information can be handled in an off-line manner, such as through a direct visit.

In the meantime, there can be used the method in which a dedicated program, which includes a list of basic notice messages and a list of scenarios and software connecting the user company 1 to the relay service company 2 via the Internet, is installed in the computer of the user company 1, the program is made to run, a notice message and a scenario are selected or created, data on changeable parts and the name of a file including phone numbers are input, the user company 1 is allowed to access the relay service company 2, and the above-described data are transmitted to the relay service company 2.

Meanwhile, in the present invention using VoiceXML, for the constant parts, TTS is made not to be used by using a previously recorded file. Alternatively, for the constant parts, TTS is made to be used by inputting data in text in the same way as for the changeable parts.

Although the preferred embodiment of the present invention has been disclosed, the present invention is not limited to this embodiment, but it should be noted that various modifications are possible without departing from the spirit of the invention as disclosed above.

For example, although VoiceXML has been described as being used as a representative markup language, a scenario can be constructed by using VoiceXML together with SSML, CCXML and SRGS.

For example, if the scenario “press buttons 1, 2 and 3 if you want the oral narration of a fairy tale, hotel reservation and a telephone conference, respectively” that is written in VoiceXML exists during ARS voice notice, the relay service company 2 may prepare a scenario related to the narration of a fairy tale in SSML, a scenario related to the hotel reservation in SRGS, and a scenario related to the telephone conference in CCXML.

The communication network company 5 has an SSML interpretation server, an SRGS interpretation server and a CCXML interpretation server, together with a VoiceXML interpretation server.

Accordingly, when the scenario is transmitted to the relay service company 5, a VoiceXML code corresponding to the scenario “press buttons 1, 2 and 3 if you want the oral narration of a fairy tale, hotel reservation and a telephone conference, respectively” is interpreted by the VoiceXML server, a customer is called and a ARS voice notice corresponding to this scenario is performed.

If a customer having listened to the ARS voice notice presses button 1, the scenario prepared in SSML is interpreted by the SSML interpretation server and the fairy tale is narrated. If the customer presses button 2, the scenario prepared in SRGS is interpreted by the SRGS interpretation server and the hotel reservation is performed. If the customer presses button 3, the scenario prepared in CCXML is interpreted by the CCXML interpretation server and the telephone conference is performed.

As described above, in accordance with the present invention, respective user companies 1 can perform ARS voice notice based on contacts with the relay service company 2, so that mass costs required to construct and maintain respective ARS voice notice systems can be reduced.

What is claimed is:

1. A processing method in a computer for relay service, comprising the steps of:
receiving information about constant parts of a scenario for a voice notice message, information about changeable parts thereof related to respective customers, and information about phone numbers of the customers;
creating markup language code based on the received information; and
transmitting the created markup language code to a communication network so that the communication network communicates with customers and performs Automatic Response System (ARS) voice notice.

2. The method as set forth in claim 1, wherein the information about the constant parts is previously recorded data.

3. The method as set forth in claim 1, wherein the information about the changeable parts and the information about the phone numbers are received in file form.

4. The method as set forth in claim 1, wherein the information about the constant parts are formed in such as way as to transmit a sample of the information about the constant parts to the user and, then, accept the sample by the user.

5. The method as set forth in claim 4, wherein, if the sample is not acceptable, the user directly creates the information about the constant parts.

6. The method as set forth in claim 1, wherein the markup language includes VoiceXML.

7. A computer apparatus for relay service, comprising:
mean for receiving information about constant parts of a scenario for a voice notice message, information about changeable parts thereof related to respective customers, and information about phone numbers of the customers;
mean for creating markup language code based on the received information; and
means for transmitting the created markup language code to a communication network so that the communication network communicates with customers and performs Automatic Response System (ARS) voice notice.

8. The computer apparatus as set forth in claim 7, wherein the markup language includes VoiceXML.

9. A processing method in a computer apparatus for ARS voice notice, comprising the steps of:
receiving makeup language code from a computer apparatus for relay service of ARS voice notice that receives information about constant parts of a scenario for a voice notice message, information about changeable parts thereof related to respective customers and information about phone numbers of the customers, and creates markup language code based on the received information; and
interpreting the received markup language code, and performing ARS voice notice to the customers via a communication network.

10. The method as set forth in claim 9, wherein the information about the constant parts is previously recorded data.

11. The method as set forth in claim 9, wherein the information about the changeable parts and the information about the phone numbers are received in file form.

12. The method as set forth in claim 9, further comprising the step of connecting a customer to a call center of the user if the customer wants to communicate with the call center during the ARS voice notice or at an end of the ARS voice notice.

13. The method as set forth in claim 9, wherein the markup language includes VoiceXML.

14. A computer apparatus for ARS voice notice, comprising:
means for receiving makeup language code from a computer apparatus for relay service of ARS voice notice that receives information about constant parts of a scenario for a voice notice message, information about changeable parts thereof related to respective customers and information about phone numbers of the customers, and creates markup language code based on the received information; and
means for interpreting the received markup language code, and performing ARS voice notice to the customers via a communication network.

15. The computer apparatus as set forth in claim 14, further comprising Text-To-Speech (TTS) engine.

16. The computer apparatus as set forth in claim 14, wherein the markup language includes VoiceXML.
